(19) United States
(12) Patent Application Publication
(10) Pub. No.: US 2015/0140371 A1
(43) Pub. Date: May 21, 2015

(54) CURVED BATTERY CONTAINER

(71) Applicant: 24M Technologies, Inc., Cambridge, MA (US)

(72) Inventor: Alexander H. SLOCUM, Bow, NH (US)

(21) Appl. No.: 14/513,602

(22) Filed: Oct. 14, 2014

Related U.S. Application Data
(60) Provisional application No. 61/890,562, filed on Oct. 14, 2013.

(51) Int. Cl. H01M 2/02; H01M 10/6561; H01M 2/06; H01M 2/12

(52) U.S. Cl. CPC H01M 2/02; H01M 2/1241; H01M 10/5063; H01M 2/06; H01M 2/0202; H01M 2/0237; H01M 2002/0205
USPC 429/56; 429/163; 429/186; 429/72; 429/179

(57) ABSTRACT

A curved container for electrochemical battery cells manufactured with an open side into which the battery cells are placed along with a resilient structure such that when the lid is placed on the container and attached/sealed, the battery cells are sealed in the container and preloaded against the large top and bottom surfaces of the container. Electrical contacts feed through one edge of the container to enable the electrical power generated by the cells to be safely accessed, and the cells can be safely charged without external atmospheric leaks into the container, or gases generated during battery use to escape. The containers can be stacked on edge next to each other as a stack but without the need to compress the stack to maintain battery cell compression, which enables a container to be easily replaced without having to dissemble the stack.

### CROSS REFERENCE TO RELATED APPLICATIONS

This application claims priority to and the benefit of U.S. Provisional Patent Application Ser. No. 61/890,562, filed Oct. 14, 2013, entitled “Curved Battery Container,” the disclosure of which is hereby incorporated by reference in its entirety.

### BACKGROUND

Embodiments described herein relate generally to a container for electrochemical cells (also referred to herein as “battery cells” or “electrochemical battery cells”). More particularly, the present invention relates to curved structural containers for housing high energy density battery cells where the container maintains dimensional accuracy and structural integrity even when internal pressure increases due to the electrochemical process causing the internal pressure and/or size of the cells to change. Furthermore the battery containers described herein enable the battery cells to be preloaded from within the structure without the need for external clamp pressure, thereby maintaining near uniform pressure on the cells which can lead to longer battery life.

Some battery cells are configured to be under constant compression in order to maintain proper contact between the active material (e.g., electrolyte) and the current collectors and the separator. Some batteries generate gas during the initial formation stage (initial charge/discharge cycles), and can even generate small amounts of gas during operation. This gas generation can lead to changes in size of the battery container during use and thus adversely impact the contact between the electrode materials. In addition, the operation of the battery itself can lead to changes in the size of some of the electrolyte elements.

To accommodate these conditions, the electrochemical cells of some batteries are packaged in a soft pouch. Multiple pouches are then stacked together and compressed using spring tensioned tie rods and rigid end plates. If one electrochemical cell malfunctions, it can be a major undertaking to replace the malfunctioned cell (pouch). Some batteries are packaged in rigid rectilinear containers with pressure relief valves, which can then be stacked in a battery pack. Any breaching of the valve can lead to moisture and oxygen intake, which can be harmful to battery life. Furthermore, these rectilinear containers often do not provide even pressure to the cells because the sides can bulge with internal pressure and the resulting non-uniform pressure on the cells can lead to performance degradation.

It is well known in the art of electronic systems that devices in containers, such as disk drives, power supplies, batteries, etc. generate heat and external features such as ribs and surface roughness treatments have been used to try and increase convection coefficients to aid in cooling of such devices. The addition of ribs to a battery container may at first glance be thought to help with heat transfer. However, the dominant resistance path is through the battery material itself, so the surface area added by the ribs for cooling may not have a significant effect on the cooling ability of the system as might be desired. While adding surface roughness or texture to the battery containers can increase the heat transfer coefficient of the containers, maintaining good contact between the battery cell stacks and the battery container, as well as improving air flow between a plurality of battery containers included in a battery pack, are typically more effective ways of improving heat transfer and controlling the temperature of batteries.

Thus, it is an enduring goal of energy storage system development to develop new battery containers that are stronger and stiffer, enable maintaining uniform and constant pressure on the electrochemical cells, and between the cells and the inside walls of the container, and allow for efficient air flow between stacked containers.

### SUMMARY

Embodiments described herein relate generally to a container for electrochemical battery cells. More particularly, the embodiments described herein relate to an electrochemical cell including a container which includes a first portion and a second portion that define an interior volume therebetween. The first portion includes a first surface having a first radius of curvature. The second portion includes a second surface having a second radius of curvature such that the second surface is opposite the first surface and the second radius of curvature is different than the first radius of curvature. An electrochemical cell is disposed in the inner volume and includes an anode, a cathode and a separator disposed between the anode and the cathode. In some embodiments, the electrochemical cell includes a resilient structure disposed in the inner volume and configured to exert a compressive load on the electrochemical cell stack. In some embodiments, the electrochemical cell includes a first electrochemical cell stack and a second electrochemical cell stack, and the resilient structure is disposed between the first electrochemical cell stack and the second electrochemical cell stack.

A principal object of this disclosure, therefore, is to provide a curved container for electrochemical battery cells.

A further object of this disclosure is to provide a container with an open side into which electrochemical cells can be placed along with a resilient structure such that when the lid is coupled to the container and sealed, the battery cells are sealed in the container and preloaded to provide uniform pressure to all the cells.

A further object of this disclosure is to provide electrical contacts that feed through one side of the container to enable the electrical power generated by the cells to be safely accessed, and the cells to be safely charged without external atmospheric leaks into the container, and/or to allow gases, generated during battery use, to escape in an uncontrolled fashion.

A still further object of this disclosure is to enable the containers to be disposed in a stack without the need to compress the stack to maintain battery cell compression.

A still further object of this invention is to enable a container to be easily replaced without having to dissemble the stack.

### BRIEF DESCRIPTION OF THE DRAWINGS

FIG. 1 shows a schematic block diagram of a curved battery container according to an embodiment.

FIG. 1a is a side view of a curved battery container according to an embodiment.

FIG. 1b is a bottom isometric view of the battery container of FIG. 1a.

FIG. 1 c is a top isometric view of the battery container of FIG. 1a.

FIG. 1d is an end view of the battery container of FIG. 1a.

FIG. 1e is a top view of the battery container of FIG. 1a.

FIG. 1f is a side cross-section view of the battery container of FIG. 1a.

FIG. 1g is an enlarged side cross-section view of a portion of the battery container of FIG. 1f identified by the line 1g.

FIG. 1h is an enlarged side cross-section view of a portion of the battery container of FIG. 1g identified by the line 1h.

FIG. 2a is an isometric view of a single current collector included in the electrochemical cell stack of FIG. 1g.

FIG. 2b is an isometric view of a single separator included in the electrochemical cell stack of FIG. 1g.

FIG. 2c is an isometric view of the electrochemical cell stacks prior to being inserted into the battery container of FIG. 1a.

FIG. 2d is an enlarged isometric view of the end of the cell stacks of FIG. 2c identified by the line 2d.

FIG. 3 is an isometric view of a stack of battery containers according to an embodiment.

FIG. 4 is an isometric view of a stack of curved battery containers according to an embodiment.

FIG. 5a is a top view of a single battery container included in the stack of FIG. 4.

FIG. 5b is a side view of the battery container of FIG. 5a.

FIG. 5c is a side cross-section view of the battery container of FIG. 5a, taken at line E.

FIG. 5d is an enlarged side cross-section view of the portion of the battery container of FIG. 5c identified by the line 5d.

FIG. 5e is a top isometric view of the container of the battery container of FIG. 5a with a lid removed.

FIG. 5f is an enlarged isometric view of the corner of the battery container of FIG. 5e identified by the line 5f.

FIG. 6a is an isometric view of the cell stacks included in the battery container of FIG. 5a.

FIG. 6b is an enlarged isometric view of the anode end of the cell stacks of FIG. 6a identified by the line 6b.

FIG. 6c is an enlarged isometric view of the end of the cathode end of the cell stacks of FIG. 6a identified by the line 6c.

FIG. 7a shows the stress results of finite element analysis on a flat container subject to one atmosphere internal pressure.

FIG. 7b shows the deflection results of finite element analysis on the flat container.

FIG. 8a shows the stress results of finite element analysis on a curved container subject to one atmosphere internal pressure.

FIG. 8b shows the deflection results of finite element analysis on a curved container.

### DETAILED DESCRIPTION

Battery enclosures (also referred to herein as “containers” or “housings”) described herein are configured to be lightweight and occupy minimal volume with respect to the volume of the battery cells in order to maintain power/volume efficiency. Merely adding wall thickness to a traditional rectilinear battery container will not yield a strong enough container but it will certainly add much cost and weight. The goal of the embodiments described herein is to use fundamental structural principles to design a strong lightweight container for battery cells.

Structural efficiency can be obtained with curved structures. For example, a 2D curved plate is inherently much stronger than a flat plate. In other words, an arch is typically stronger than a straight span. A 3D curved plate would be stronger and stiffer than a flat plate. Known battery containers have been made rectilinear to accommodate flat stacks of battery cells. However, if the individual cell elements are disposed initially on curved surfaces, for example curved current collectors, or if they have flexibility, they can be assembled as arc-shaped cells that can then be loaded into an arc shaped battery container. Non-structural curved pouches and containers for some battery types have been created to allow an electrochemical cell stack contained therein to conform to the packaging, for example a curved packaging of a consumer product. Such known containers, however, are designed to merely hold the electrolyte and are not configured provide any structural support to the cell. Therefore, such containers cannot maintain a preload on the cells, nor can they resist gas pressure generated by some cell chemistries.

Furthermore, traditional rectilinear battery containers are typically long, deep-drawn structures and the battery elements are slid into the end of the structure in a manner analogous to a sliding drawer. In such configurations, there is no easy way to place cell stacks into a battery container having a preload spring coupled thereto, such that it might provide preload compression to the stack. However, if the container is made as a curved structure, then it can be formed, for example using a fine blanking, hydroforming, or even a molding process, as an open sided structure where the open side is parallel to a large surface of the battery cell. The battery cells would be laid into the container like a sandwich placed inside a plastic container and the lid then placed on the container to compress the cells and then the lid would be attached and sealed to the container.

Embodiments described herein relate generally to curved containers for electrochemical battery cells. Embodiments of the containers described herein offer several advantages over conventional flat rectilinear battery containers including, for example; (a) the curved battery containers are inherently stronger and stiffer than flat rectilinear containers without being thicker or heavier; (b) the containers open from a side which allows easy loading of a cell stack into the containers; (c) the side opening enables easy installation of a preloading spring or a resilient structure within the cell stack to provide preload compression to the cell stack; and (d) the containers are configured to define sufficient clearance for air flow between adjacent curved battery containers when disposed in a stack, thereby enabling more efficient cooling of the containers.

In some embodiments, an electrochemical cell includes a container that includes a first portion and a second portion that define an inner volume therebetween. The first portion includes a first surface having a first radius of curvature. The second portion includes a second surface having a second radius of curvature. The second surface is opposite the first surface and the second radius of curvature is different than the first radius of curvature. An electrochemical cell is disposed in the inner volume and includes an anode, a cathode and a separator disposed between the anode and the cathode. In some embodiments, the electrochemical cell includes a resilient structure disposed in the inner volume and is configured to exert a compressive load on the electrochemical cell stack. In some embodiments, the electrochemical cell includes a first electrochemical cell stack and a second electrochemical cell stack and the resilient structure is disposed between the first electrochemical cell stack and the second electrochemical cell stack.

In some embodiments, an electrochemical cell includes a container including a first portion and a second portion and defining an inner volume therebetween. An electrochemical cell stack is disposed in the inner volume and includes an anode, a cathode and a separator disposed between the anode and the cathode. The electrochemical cell further includes a resilient structure (component) disposed in the inner volume, such that the resilient structure is configured to preload the electrochemical cell stack with a uniform compressive force. In some embodiments, the resilient structure is formed of steel wool, typically stainless steel wool or other material resistant to corrosion in the presence of the battery electrolyte. In some embodiments, the electrochemical cell includes a first electrochemical cell stack and a second electrochemical cell stack such that the resilient structure is disposed between the first electrochemical cell stack and the second electrochemical cell stack, and is configured to preload the first electrochemical cell stack and the second electrochemical cell stack with a uniform compressive force.

In some embodiments, a battery module can include a first electrochemical cell and a second electrochemical cell disposed in a stack such that a gap is present between a first surface of a first portion of the first electrochemical cell and a second surface of a second portion of the second electrochemical cell.

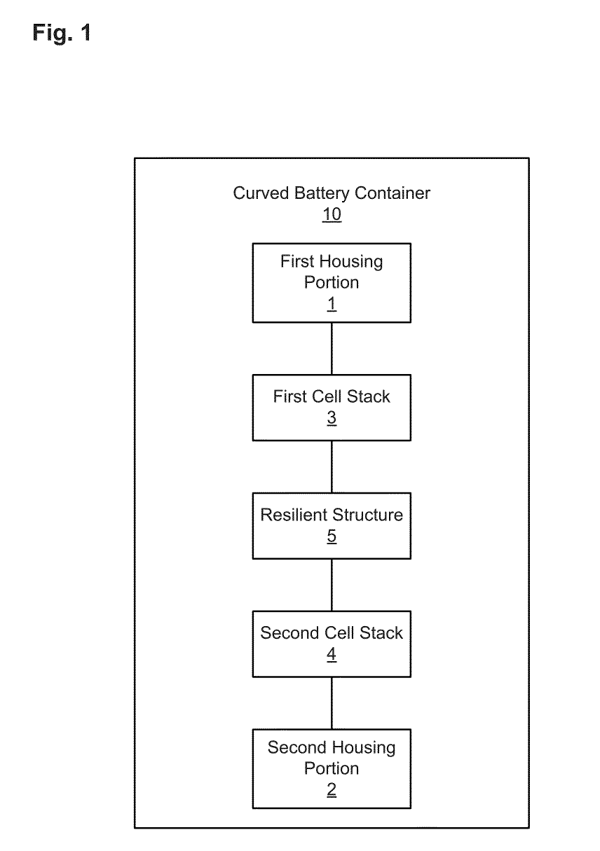

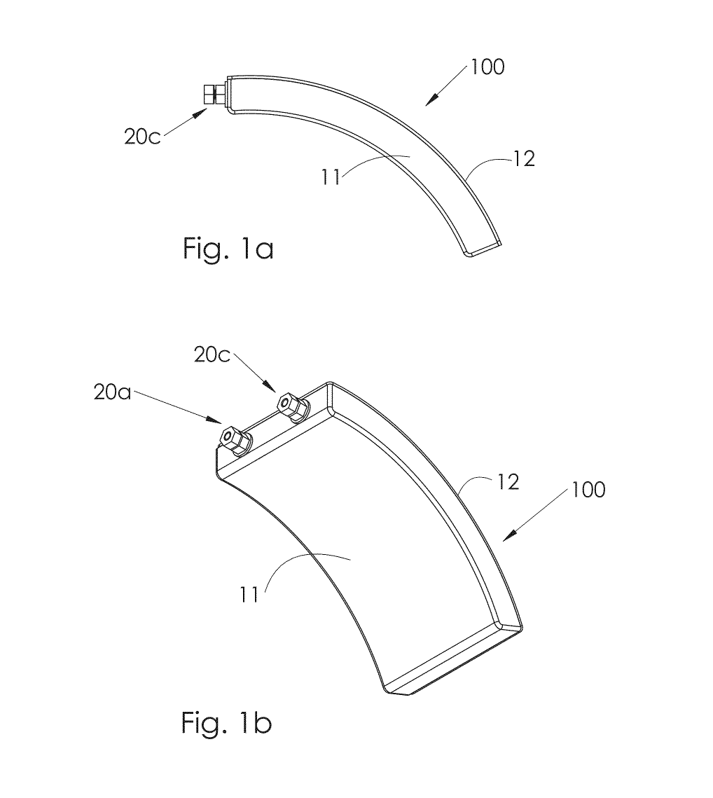

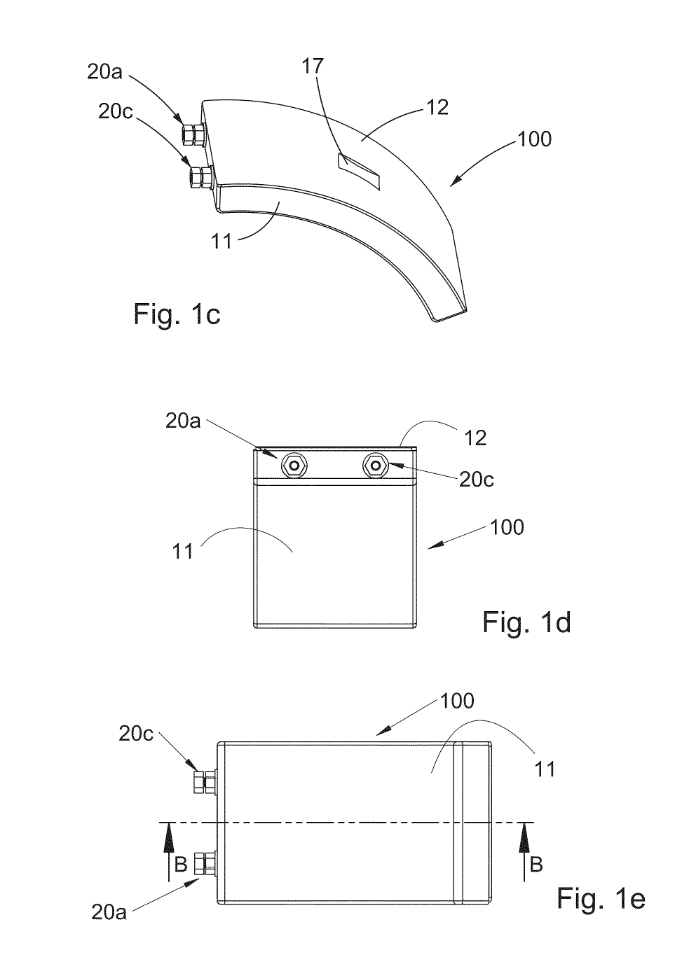

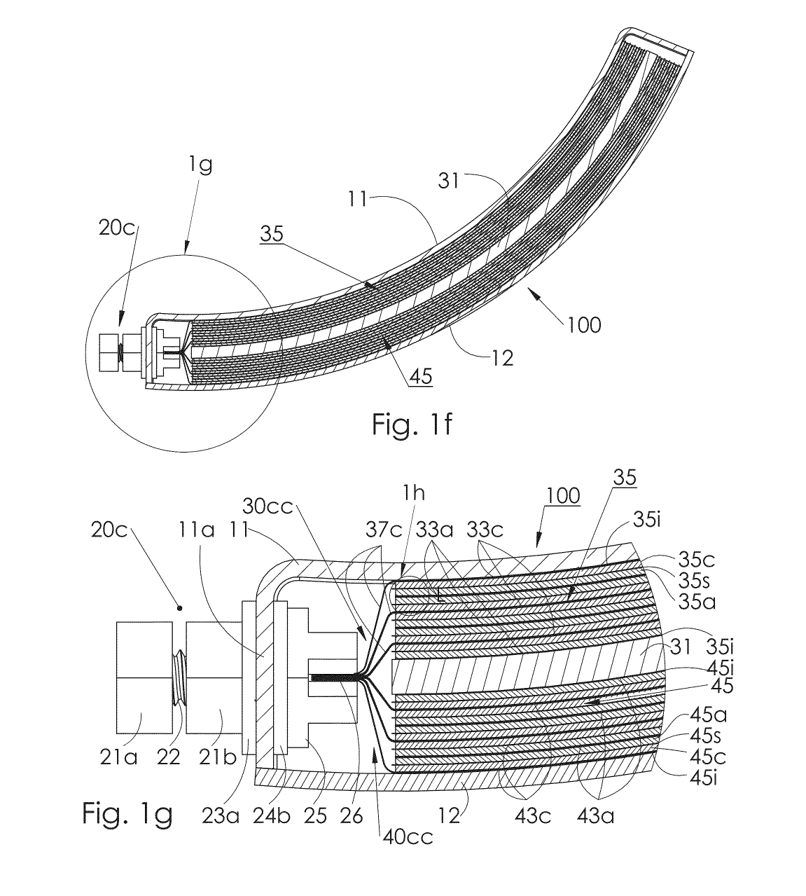

Referring now to FIG. 1, a curved battery container 10 includes a first housing portion 1 and a second housing portion 2. A first cell stack 3 and a second cell stack 4 are disposed in the curved battery container 10 and separated by a resilient structure 5 disposed therebetween.

In some embodiments, the first housing portion 1 defines an inner volume for housing the components of the battery. The first housing portion 1 includes a first surface, for example a base that is curved with respect to a longitudinal axis of the curved battery container 10, such that the first surface has a first radius of curvature. In some embodiments, the first surface can define a plurality of curves, for example, two curves, three curves, or four curves, such that the curved battery container 10 can be a bi-wave, tri-wave, or quad-wave battery container. The first housing portion 1 can be made of a strong and heat resistant material, for example, metals (e.g., stainless steel, aluminum, metal alloys, any other suitable metal or combination thereof), plastics, carbon filled plastic, polymers, any other suitable material or combination thereof. Combinations of materials are also possible such as, for example, a plastic-based material for the overall structure, with a metal coating as an oxygen barrier.

The first housing portion 1 can be formed using any manufacturing process such that a side of the first housing portion 1 is open. For example, the first housing can be formed by deep drawing, fine blanking, stamping, molding, hydroforming, injection molding, blow molding, or any other suitable process or combination thereof. The open side enables facile loading of the first cell stack 3 and the second cell stack 4 with the resilient structure 5 into the first housing portion 1. The bottom edges of the first housing portion 1 can be also be curved such that a first curved battery container 10 can easily be stacked on a second curved battery container (not shown). In some embodiments, the bottom edges can be straight. A side wall of the first housing portion 1 can include a first cavity and a second cavity for a first electrical terminal (not shown) and a second electrode terminal (not shown), which are configured to receive the electrical leads from current collectors (e.g., positive and negative current collectors) of the electrode stacks. In some embodiments, the cavities can be disposed on a flat side wall of the first housing portion 1. In some embodiments, the cavities can be disposed on a curved sidewall of the first housing portion 1. In some embodiments, the first housing portion 1 can also include a plurality of ribs, for example, to add strength to the first housing portion 1 or facilitate heat transfer. In some embodiments, the first housing portion 1 can include portions of varying thickness, for example the central portion of the base of the first housing portion 1 can be thicker than the edges of the first housing portion 1 which can increase the stiffness of the curved battery container 10, to reduce bowing.

In some embodiments, the second housing portion 2 can be configured to be coupleable to the first housing portion 1 such that the first housing portion 1 and the second housing portion 2 define an inner volume for housing the first cell stack 3, the second cell stack 4, and the resilient structure 5. The second housing portion 2 includes a second surface that is also curved with respect to a longitudinal axis of the electrochemical cell 10. In some embodiments, the second surface of the second housing portion 2 can be opposite the first surface of the first housing portion 1 such that the second surface has a radius of curvature different than the first radius of curvature. In some embodiments, the second housing portion 2 can be a lid which can be coupled to the first housing portion 1 using any suitable method, for example welding, gluing, crimping, or with a seal a snap-fit, bolted or riveted, or an other coupling mechanism, such that the lid for all intents and purposes hermetically seals the first housing portion 1 to prevent moisture from entering the battery container. The radius of curvature of the second housing portion 2 can be slightly larger than the radius of curvature of the first housing portion 1 such that when the second housing portion 2 is disposed on the first housing portion 1, a middle portion of the second housing portion 2 initially touches the first housing portion 1 and then it effectively rolls into place as the ends are pushed down. This can, for example provide a tight seam for welding the second housing portion 2 to the first housing portion 1. Furthermore, this can ensure that the cell stacks are first compressed in the middle and the compression rolls out to the edges of the stack as a wave, which can help to remove any creases or bubbles from the cell stack. In some embodiments, the second housing portion 2 can have one curve. In some embodiments, the second housing portion 2 can be a bi-wave, a tri-wave, or quad-wave lid offset from the waves included in the first housing portion 1. In some embodiments, the second housing portion 2 can also include ribs, or have varying thickness to add stiffness to the second housing portion 2, for example thicker in the center and thinner at the edges or vice versa in order to maximize stiffness and minimize weight or to facilitate heat transfer. In some embodiments, at least one of the first housing portion 1 and the second housing portion 2 can also include a frangible portion, for example a portion of reduced thickness, for example located in the center of the second curved surface of the second housing portion 2. The frangible portion can serve as a safety region configured to rupture when an internal gas pressure within the inner volume exceeds a predetermined pressure, for example in the case of catastrophic cell failure, to allow the gas to escape and thus prevent the electrochemical cell 10 from exploding.

In some embodiments, a first electrochemical cell 10 and a second electrochemical cell can be disposed in a stack such that a gap is present between the first surface of the first electrochemical cell and a second surface of the second electrochemical cell. In other words, when a plurality of the electrochemical cells 10 are stacked, the electrochemical cells 10 touch each other on their ends, but there is a gap between them in the middle region which allows for sufficient cooling air flow.

Each of the first cell stack 3 and the second cell stack 4 can include one or more cathode layers and anode layers separated by a separator layer. The separator can include a die cut sheet placed between the cathode the anode. The leads of each of the plurality of positive current collectors are coupled together and coupled to the electrical terminal (e.g., the first electrical terminal). Similarly, the leads of each of the negative current collectors are coupled together and then coupled to the electrical terminal (e.g., the second electrical terminal). Each of the cathode layer, the anode layer, the separator, the positive current collector, and the negative current collector can include any formulations, materials, or structure as are commonly known in the art.

The resilient structure 5 can be disposed in between the first cell stack 3 and the second cell stack 4, and is configured to apply a compressive load on the cell stacks. The resilient structure 5 can include, for example, a foam piece or a structural micro-spring array plate (e.g., a stainless steel wool pad, or a micro-spring array). Steel (e.g., stainless steel) wool can be particularly suitable as a resilient structure to load a large surface, for example the first cell stack 3 and the second cell stack 4, uniformly. Furthermore the use of steel wool as a resilient structure is not limited to the electrochemical cells described herein. Steel wool can also be used as a resilient structure between conventional flat batteries packaged in rectilinear containers or pouches, to preload a fuel cell stack, or any other electrochemical cell or object requiring a uniform consistent preload pressure to be applied across its surface. In each of these applications, non-uniform preload or a preload that changes with time can lead to a system performance loss. Unlike a polymer based resilient structure (e.g., a rubber or foam pad), however, steel wool does not creep, can have acceptable hysteresis under cyclic loading, and therefore can provide a uniform substantially consistent preload for longer periods of time.

The side opening of the electrochemical cell 10 can allow the first cell stack 3 and the second cell stack 4 to be disposed in the inner volume defined by the first housing portion 1 and the second housing portion 2 with the resilient structure 5 disposed therebetween (e.g., as compared to battery containers which are open at the edge). This allows uniform preloading of the first electrochemical cell stack 3 and the second electrochemical cell stack 4, when the second housing portion 2 is coupled to the first housing portion 1. By placing the resilient structure 5 between the two cell stacks (in the middle between them), the heat transfer conduction path from the first cell stack 3 and/or the second cell stack 4 is reduced as compared to if the resilient structure 5 was placed in the inner volume and then the entire stack of cells placed on it. The preloaded cell stacks are in contact with the first curved surface of the first housing portion 1 and the second surface of the second housing portion 2, which produces more uniform heat transfer to the first surface and the second surface, such that heat generated by the cell stacks can be more efficiently removed from the electrochemical cell 10 by forced or natural convection. In some embodiments, such as for example, thin batteries or batteries that have very low C rates so the heat generated from use is low, the electrochemical cell 10 can include a single electrochemical cell stack and the resilient structure 5 can be disposed adjacent and in contact with the first surface or the second surface.

Having described above various general principles, several exemplary embodiments of these concepts are now described. These embodiments are only examples, and many other configurations of curved battery containers for housing electrochemical cells, are also contemplated.

Referring now to FIGS. 1a-h, a curved battery container 100 includes a housing 11 having a lid 12 coupled thereto and electrical terminals 20a and 20c coupled with the internal cathode and anode plates of the battery. A first cell stack 35 and a second cell stack 45 are disposed in the curved battery container 100 such that a resilient structure 31 is disposed therebetween.

In FIG. 1 c a pressure relief region 17 is shown, where the lid 12 has a thinner region so if the internal pressure becomes too high, for example due to gas release, the pressure relief region would break locally instead of the entire container rupturing.

The housing 11 can be made from a strong and heat resistant material, for example, metals (e.g., stainless steel, aluminum, metal alloys, any other suitable metal or combination thereof), plastics, carbon or glass fiber filled plastic, polymers, any other suitable material or combination thereof. The housing 11 can be formed using any manufacturing process such that a side of the housing 11 is open. For example, the housing 11 can be formed by deep drawing, blanking, fine blanking, hydroforming, stamping, injection molding, blow molding, vacuum forming, any other suitable process or combination thereof. A base of the housing 11 includes a first surface that defines a first radius of curvature. The open side enables facile loading of the first cell stack 35 and the second cell stack 45 with the resilient structure 31 into the housing 11 of the curved battery container 100. The bottom edges of the housing 11 can also be curved such that a first curved battery container 100 can easily be stacked on a second curved battery container 100. In some embodiments, the interface between the housing cover plate 12 (also referred to herein as “lid”) and the housing 11 can be prepared using a diamond flycutting machine. The diamond tool would have a very low wear rate in aluminum and the resulting smooth surfaces (e.g., mirror quality) can be desirable for ultrasonic welding to yield a hermetic seal. The lid 12 has a second surface that defines a second radius of curvature, which is different than the first radius of curvature of the base of the housing 11.

As shown in the side cross-section views of FIG. 1f-h, the resilient structure 31 keeps the cell stacks preloaded and pressured against the sidewalls of the container 100. The resilient structure 31 can include a micro-spring array, stainless steel wool of sufficient density (weight) or foam pad as long as it is compatible with the electrolyte and will not substantially creep with time under load or substantially change its spring rate with varying loads (have low hysteresis). Stainless steel wool pads, such as used for floor polishing machines, are dense and strong and have a spring constant typically on the order of 100 N/mm for a thickness on the order of 6-10 mm. In some embodiments, foamed rubber or any suitable metal microspring plates can also be used.

Electrically insulating layers 35i and 45i are placed between the cell stacks and the container 100 sidewalls, and the resilient structure 31 to prevent electrical shorts. Feed through holes in the end wall 11a are configured to receive the electrical terminals 20a and 20c and are sealed and kept from shorting with the container 100 by gasket washers 23a and 24b. The first electrical terminal 20a and the second electrical terminal 23c can be substantially similar to each other. The electrical terminal 23c includes an internal head 25 with a slot or clamp 26 for receiving a plurality of leads 30cc of the cells 35 (leads 37c which are extensions of the current collectors 33c), and leads 40cc of the cells 45 to be gathered and held in electrical contact with the electrical terminal 20c. A body 22 of the electrical terminal 20c passes through the sidewall 11a of the housing 11 and a nut 21b holds the electrical terminal 20c in place. The nut 21b compresses the gasket washers 23a and 24b to prevent gases from flowing either into or out of the container 100. A second nut 21a can be used to attach a cable to the electrical terminal 20c. In some embodiments, the first electrical terminal 20a and/or the second electrical terminal 20c can be plug-type connectors, for example a banana connector, a hex nut structure, a pin connector, or any other plug-type connector.

The first cell stack 35 includes a plurality of anode layers 35a and a plurality of cathode layers 35c, separated by a plurality of separator layers 35s, for example as in a traditional lithium ion battery. Similarly the second cell stack 45 also includes a plurality of cathode layers 45c and a plurality of anode layers 45a, which are separated by a plurality of separators 45s. In some embodiments, the first cell stack 35 and/or the second cell stack 45 can be a conventional double sided cell stack that has the anode/cathode layer deposited on both sides of the anode/cathode current collector. In other words, conventional double-sided cell stacks made in a conventional Li-ion battery manufacturing process can also be packaged in the container 10.

The battery cell elements included in the first cell stack 35 and the second cell stack 45 can be made on flat tooling fixtures as they conventionally are, and then assembled onto a curved fixture and then placed into the curved container 100. The lid 12 can then be put in place and then for example be crimped in place, such as done with a sardine tin for example, laser welded, or ultrasonically welded to achieve a hermetic seal. Conventional feed-throughs can also be used. In some embodiments, flexible electrodes, for example semi-solid electrodes, can also be used. Such semi-solid electrodes can be first assembled into cell stacks (i.e., the first cell stack 35 and the second cell stack 45), disposed into the housing 11 of the container 100 and then bent to conform to the curvature of the housing 11 and/or lid 12.

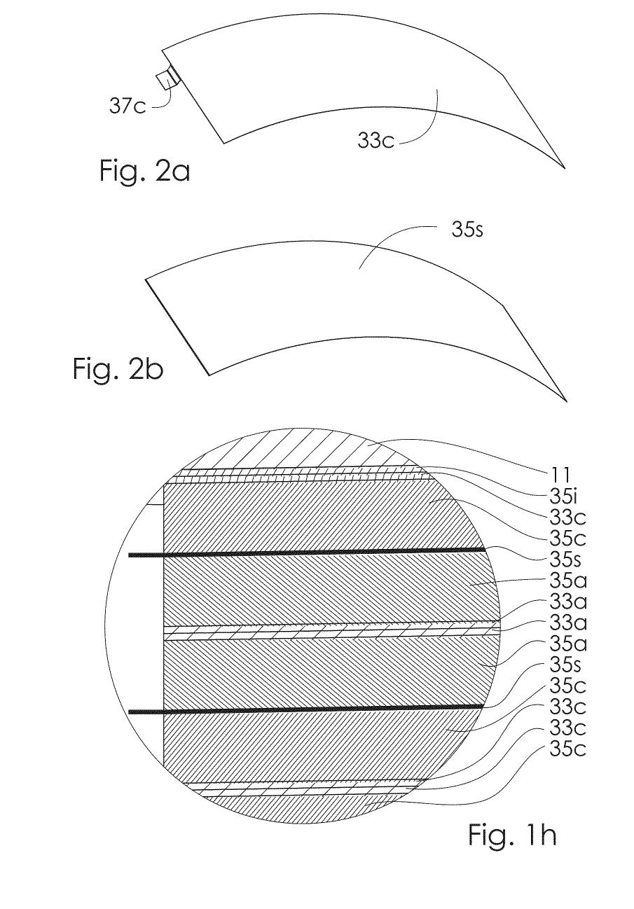

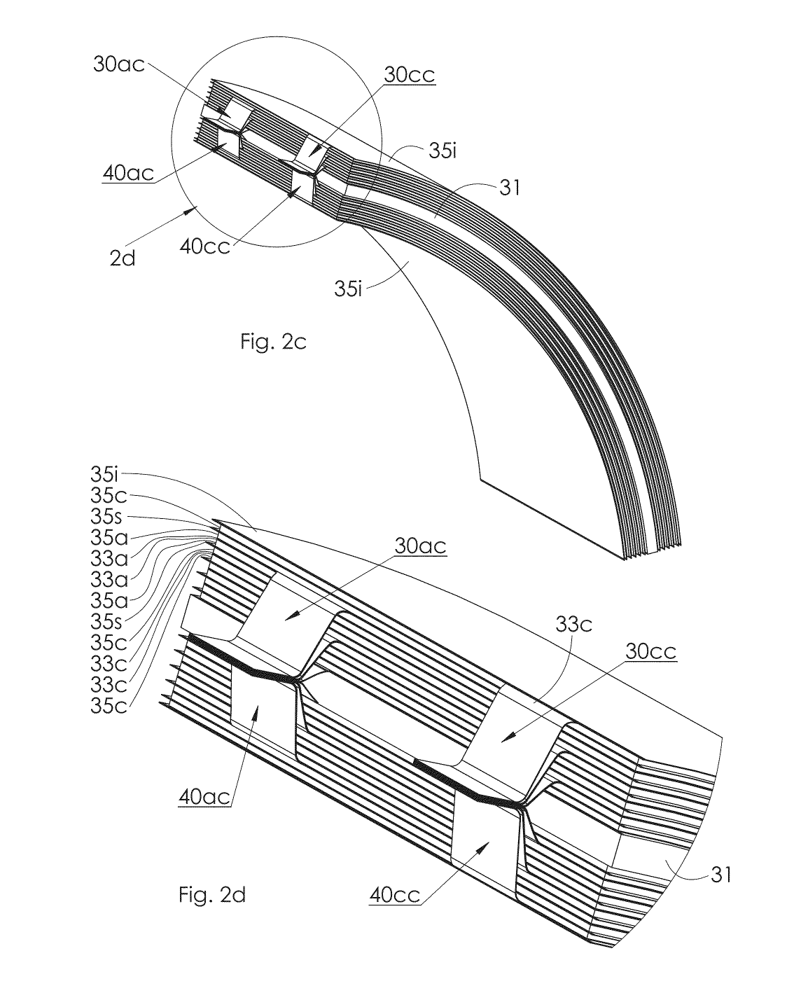

FIGS. 2a-d show further details of the cell design. In FIGS. 2a-2d, the cathode current collector 33c is shown with its lead (tab) 37c, which can be preformed before or after the cathode layer 35c is applied. The separator 35s is a die cut sheet placed between cathode layer 35c and anode layer 35a. A collection of all the leads 37c for the cathode current collectors 35c from the first cell stack 35 is 30cc and the collection of all the leads for the anode current collectors 33a of the upper cell stack 35 is 30ac. Correspondingly, for the lower cell stack 45 the anode 45a and cathode 45c lead collections are 40ac and 40cc. FIG. 2d shows the detailed layering of each component of the first cell stack 35 and the second cell stack 45 beginning with the insulating layer 35i.

This construction is particularly advantageous as it provides good contact between the stacks of cells. The large smoothly curved sidewalls of the container 100 help to ensure uniform preloading of the cell stacks, which is important to their long term functional robustness; in addition it helps to ensure a uniform heat transfer to the large container surfaces such that the heat generated by the cells is more efficiently removed from the container 100 by forced or natural convection. By disposing the resilient structure 31 between the two cell stacks, the cell stacks are pressed into intimate contact against the curved sidewalls of the container and thus the heat transfer conduction path from any one cell to the outside is reduced as compared to if the resilient structure 31 was placed in the container and then the entire stack of cells was placed on it.

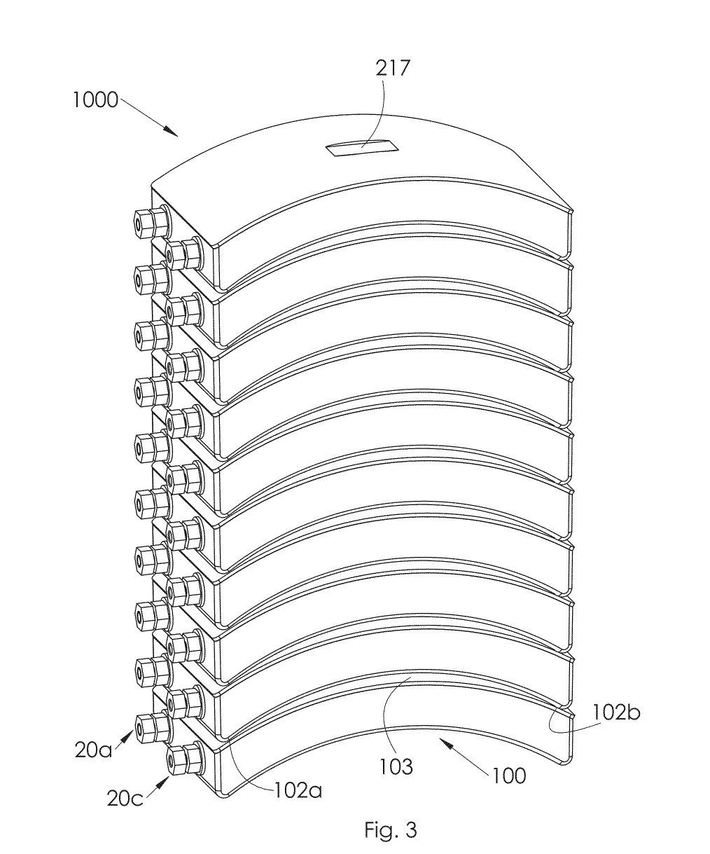

FIG. 3 is an isometric view of a stack 1000 of the containers 100. The containers 100 are disposed in the stack 1000 such that the terminals 20a and 20c of each of the container 100 are located at end of the stack 1000 where they can be connected to cables (e.g., via the nut 21a). As described herein, the radius of curvature defined by the first surface of the base of the housing 11 is different than the radius of curvature defined by the second surface of the lid 12. Hence when a plurality of the containers 100 are stacked, the containers 100 touch on their ends 102a and 102b but there is a small gap 103 between them in the middle. This configuration leaves space for air to flow to cool the stack. Furthermore, the end faces and side faces of the container 100 are also open to convective cooling flow. Thus, when the container 100 is made from a highly heat conductive material such as, for example, aluminum or heavily carbon-filled plastic, very good cooling performance can be obtained. In addition, the stiffness of the container 100 means that when a plurality of containers 100 are disposed in a battery pack, they do not need to be compressed, for example, by tie-bars (e.g., like a fuel cell stack). Hence, if one battery is not performing, it can be easily replaced without disturbing the entire stack.

A conventional rectilinear metal battery container is typically made by deep drawing so the opening is at the end, as opposed to the side opening of the container 100 described herein. Conventional containers make it harder to load the cells in a manner in which they are compressed by a resilient structure 31 (e.g., a spring). As described above, side loading the stack of cells into the container 100 enables them to be more easily loaded with the resilient structure 31 between the first cell stack 35 and the second cell stack 45 so as to make sure that the cells are always under compression and pressed up against the walls of the container 100 which also helps ensure consistent heat transfer between the cells and the container 100 for the purpose of temperature control of the battery. As shown in FIG. 1f, the battery is split into two layers (the first cell stack 35 and the second cell stack 45) straddling a middle compressed resilient structure 45) so the cells are pressed against the container 100 walls. The center of the battery (the two cell surfaces that contact the resilient structure 31) has the same thermal state as would exist if the battery were a solid and its outer surfaces were pressed against the container 100. However, conventional batteries loaded into a conventional container would not achieve this because only one side would be pressed against the inside of the conventional container, and the other side would have the resilient structure pressure. Hence by splitting the inner cell stack into two parts, very uniform preloading of pressure and excellent thermal contact on two sides is achieved.

The side load design of the container 100 does mean there will be a longer weld seam to close the container, which can easily be achieved with high speed laser welding or ultrasonic welding. The container 100 also has the benefit of being able to be manufactured by the process of fine blanking. This can enable the large bottom surface of the container 100 to be made from a flat sheet such that the housing 11 of the container 100 has a varying thickness, even though the sheet started out as having a uniform thickness. For example, starting with a 1.25 mm thick aluminum sheet, the sidewalls of the container 100 can be about 1.25 mm, and the bottom near the edges with the walls can taper from about 1.25 mm just at the corner to about 1 mm near the perimeter to about 1.5 mm in the center. This would further increase the container 100 stiffness to prevent bowing of the bottom surface and make the container stiffer (e.g., 15× stiffer) than a conventional rectilinear design. The lid 12 included in the container 100 can similarly be made by fine blanking to have a varying thickness.

To ensure a tight seam for welding or otherwise joining the lid 12 to the housing 11, the radius of curvature of the lid can be made a few percent larger than the housing 11, such that when the lid 12 is placed on the housing 11, it first touches in the middle and then it effectively rolls into place as the ends are pushed down. This ensures that the stack of cells are also first compressed in the middle and then the compression spreads out to the ends as a wave which will help prevent the forming of any creases or bubbles, and also helps to produce a very uniform preload.

In some embodiments, to reduce stress even further, ribs can be created in the fine blanking process, which can act as spacers between the containers 100 when disposed in a stack and can also act as heat transfer ribs for cooling the batteries, although as noted above, the primary thermal resistance element is typically not the convection surface, but the path through the battery materials inside the battery and then the interface between the battery cells and the inside surfaces of the container. Note that if ribs are added to a rectilinear container, and the amount of material kept constant, the container could be 2× stiffer than a traditional rectilinear container, but would still be many times less stiff than a curved container, for example the curved container 100. Stiffening ribs can be included in the housing 11 and the lids 12 such that, for example they are near zero height at the edges and increase in height towards the middle.

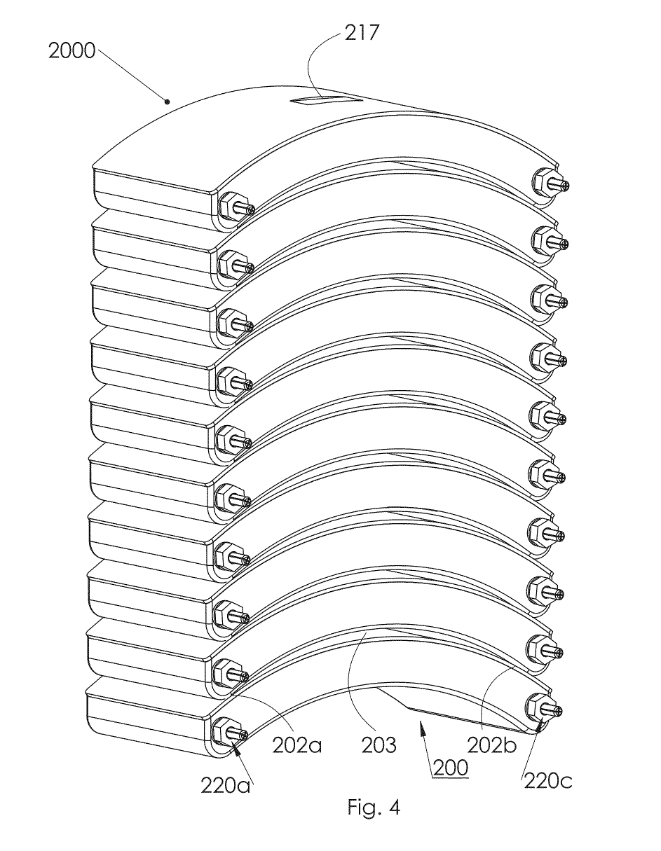

Referring now to FIG. 4-6c, a curved battery container 200 includes a housing 211, a lid 212, a first electrical terminal 220a and a second electrical terminal 220c. A first cell stack 235 and a second cell stack 245 are disposed in the curved battery container 200 such that a resilient structure 231 is disposed therebetween.

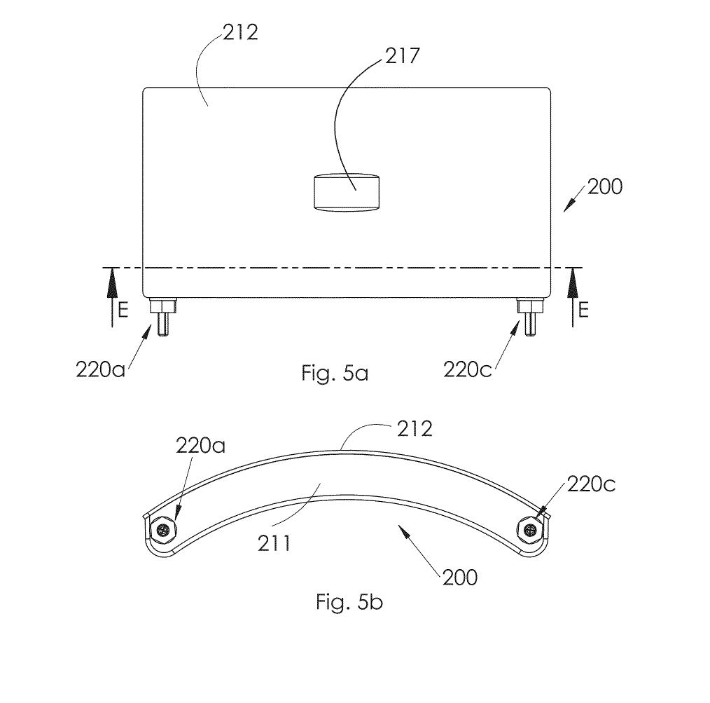

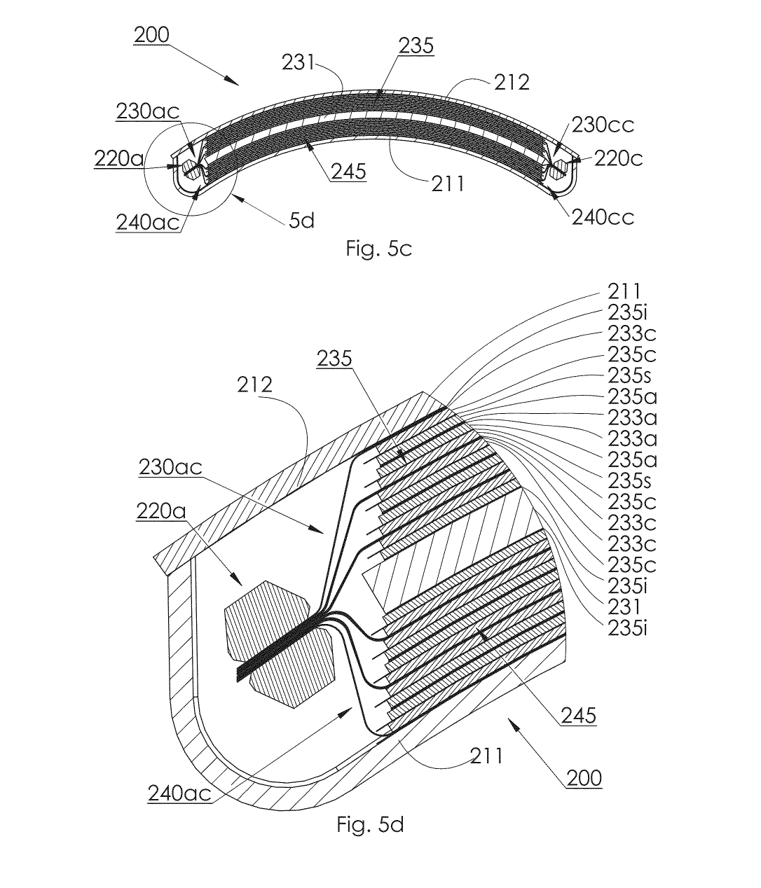

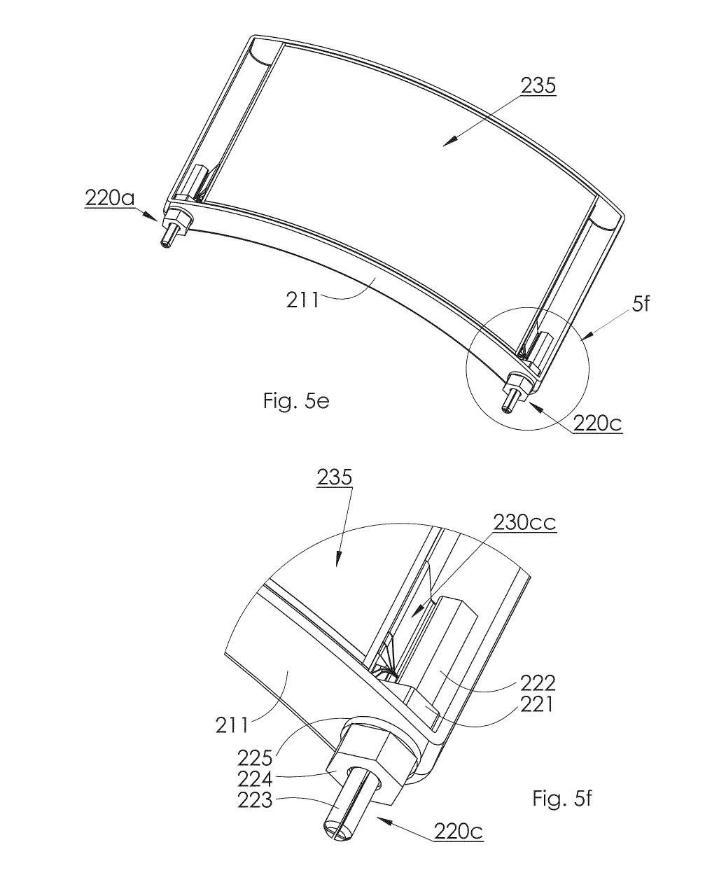

The electrical terminals 220a and 220c project out of the long side (sidewall) of the container 200. The housing 211 and the lid 212 included in the container 200 are thus substantially similar to the housing 11 and the lid 12, described with respect to the container 100, and are therefore not described in further detail herein. As shown in FIGS. 5a and 5b, the electrical terminals 220a and 220c can be of the plug type to enable the container 200 to plug into a receiving socket. With the plug-type terminals, a plurality of containers 200 can easily and quickly be inserted into a receiving bus bar (not shown) and any individual container replaced merely by pulling it out and plugging a new one into its place on the bus bar.

As shown in FIGS. 5c and 5d, the resilient structure 231 applies uniform pressure to first cell stack 235 and the second cell stack 245 respectively. Electrically insulating layers 235i keep the current collectors from shorting to the container 200 or the resilient structure 231. Cathode current collectors 233c are coated with active cathode material 235c, and anode current collectors 233a are coated with anode active material 235a. A separator 235s separates the cathode 235c and anode active materials 235a and allows for ion transfer so the battery can operate.

FIG. 5e shows the container 200 with the lid 212 removed and FIG. 5f shows an enlarged view of the cathode terminal 220c, so the topology of the cells can be seen more clearly. The terminal 220c includes a hex nut structure 221 integral with the electrical terminal, which includes receiving portion 222 for receiving the leads 220c from the cells. A hex nut 224 secures the electrical terminal 220c to the sidewall of container 200. A gasket washer 225 is disposed between the hex nut 224 and a side wall of the container 200, which is used to seal against gas flow (in either direction). In some embodiments, each of the electrical terminals 220a and 220c can be threaded to allow coupling of an electric cable or bus bar to the terminal via a nut.

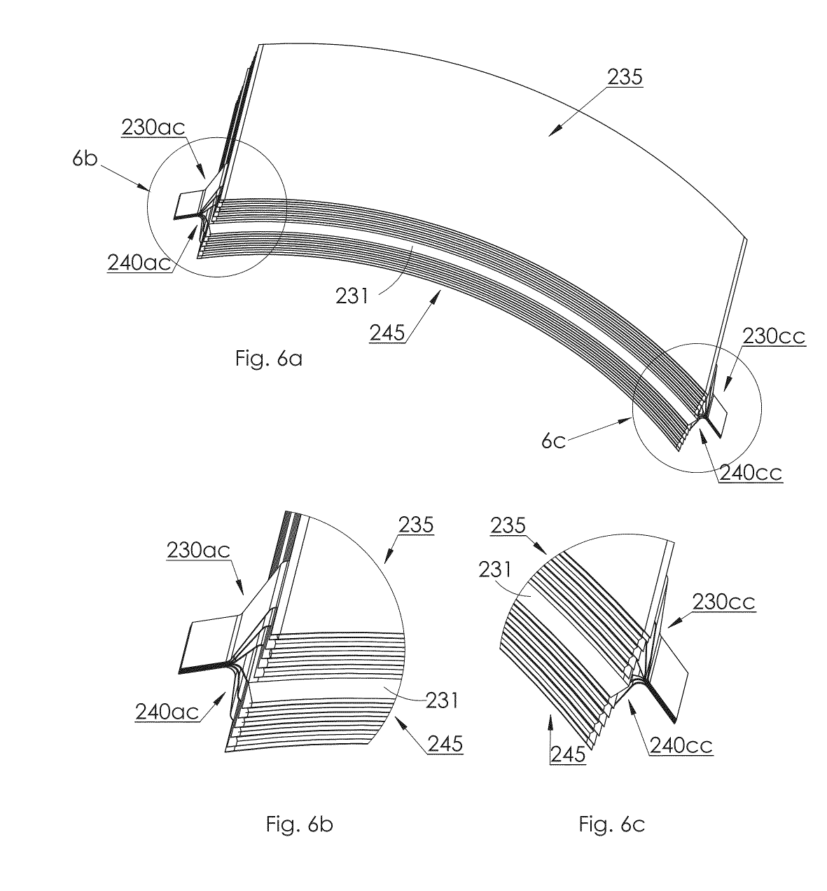

FIG. 6a shows the first cell stack 235 and the second cell stack 245 prior to being disposed in the battery container 200. The first cell stack 235 is spaced apart from the second cell stack 245 by the resilient structure 231, which keeps the two stacks pressed against the container 200 when assembled. As shown in FIG. 6b, the leads of anode current collectors from the first cell stack 235 and the second cell stack 245 are grouped together in a collection of leads 230ac and 240ac, respectively. Similarly the leads of the cathode current collectors from the first cell stack 235 and the second cell stack 245 are grouped together in a collection of leads 230cc and 240cc, respectively (FIG. 6c). The collection of leads project out the ends of the stacks so they can then be coupled with the anode terminal 220a and the cathode terminal 220c to transmit energy out of the container 200, or receive energy for charging.

According to some embodiments, a cell stack may be of a monopolar configuration (e.g., electrically parallel cells), and may comprise alternating layers of anode current collectors (e.g., having anode active material on one or both major faces thereof, depending upon its location in the cell stack) and cathode current collectors (e.g., having cathode active material on one or both major faces thereof, depending upon its location in the cell stack), with separators positioned therebetween. By way of example, an exemplary sequence (as shown in FIG. 5d) beginning at the lid 212 and ending at the resilient structure 231, may be as follows: lid 212, insulator 235i, cathode current collector 233c, cathode active material 235c, separator 235s, anode active material 235a, anode current collector 233a, anode current collector 233a, anode active material 235a, separator 235s, cathode active material 235c, cathode current collector 233c, cathode current collector 233c, cathode active material 235c, insulator 235i, and resilient structure 231.

According to other embodiments, a cell stack may, instead of or in addition to a monopolar configuration, be of a bipolar configuration, and may comprise layers of series-connected bipolar electrodes (“bipoles”) each functioning both as an anode in one cell and as a cathode in an adjacent cell. In other words, each bipolar electrode may comprise a cathode active material on one face and an anode active material on an opposite face. Bipolar stacks can begin and/or end with an “end” electrode bearing an active material on only one face. In bipolar configurations, electron-conducting membrane partitions may be disposed between the bipoles. Additionally, bipolar configurations can require fewer leads, such that electrical connection need only be made to the “end” electrodes at the ends of the bipolar stack(s).

FIG. 4 shows a stack 2000 of the containers 200. There is a gap 203 between each of the containers 200 because of the different radii of curvature between the bottom and top side surfaces, which touch on their ends at 202a and 202b. This allows for sufficient air flow between each of the containers 200 allowing for effective heat transfer and cooling of the containers 200.

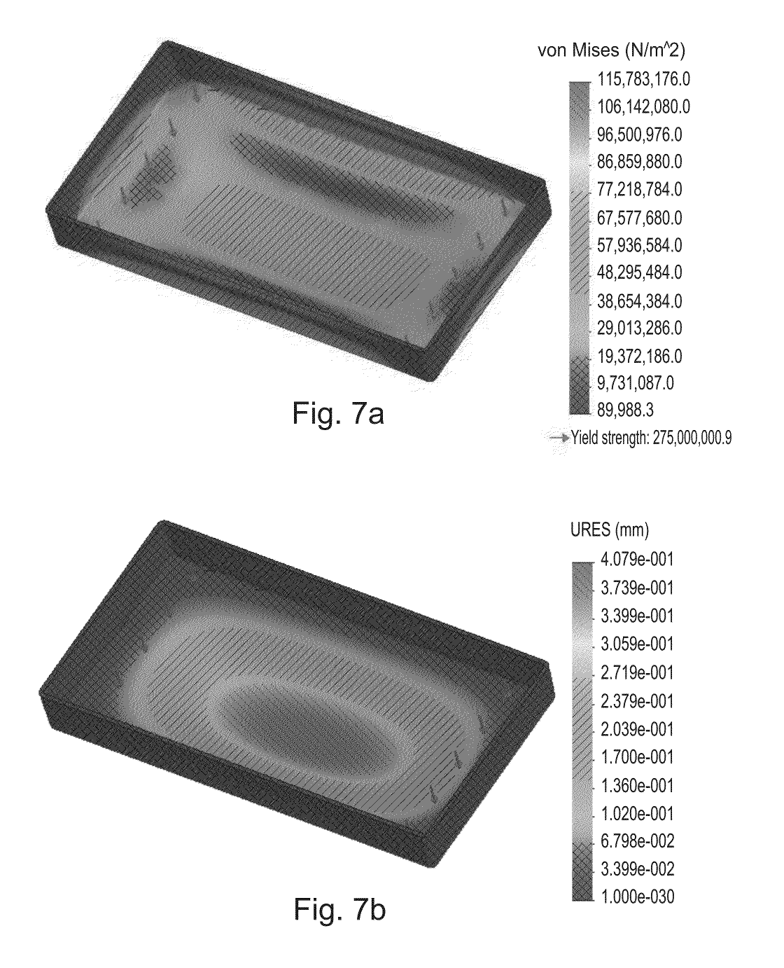

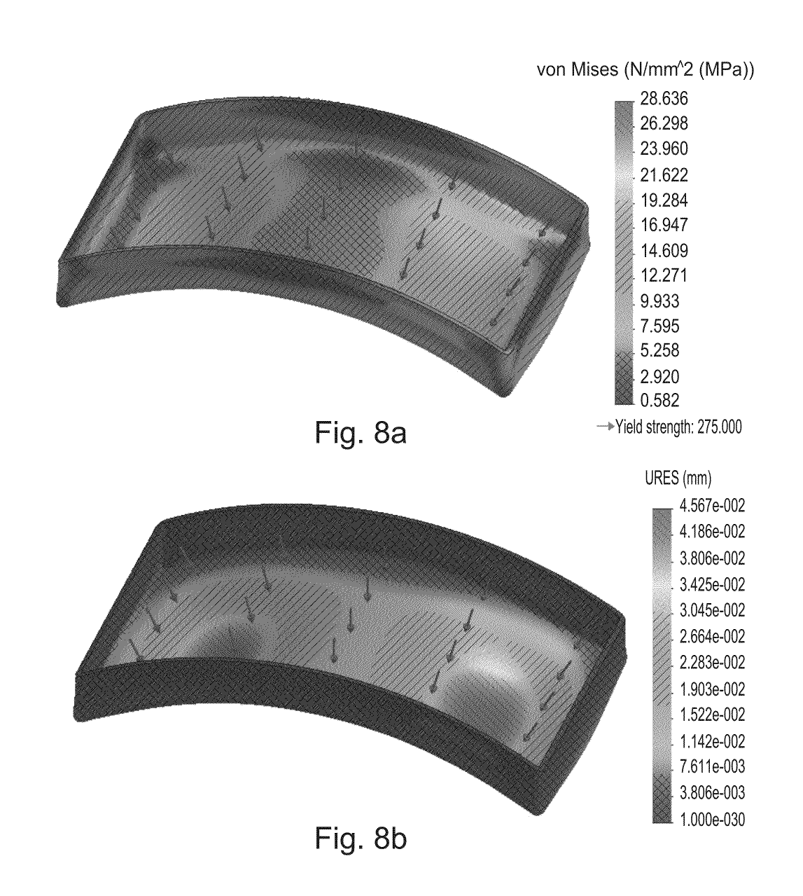

Finite element (FEM) analysis was performed on various configurations of curved containers and compared with FEM analysis performed on equivalent volume conventional (flat) rectilinear containers to demonstrate the higher stiffness of the curved containers, for example, the curved container 100, 200 or any other curved container described herein. FIGS. 7a and 7b show the stress and deflection, respectively, in a 1.25 mm wall thickness aluminum conventional rectilinear container configured to house an 80 cm² cell stack. The conventional rectilinear container was subjected to a 1 atm internal pressure (lid removed, top surface fully constrained for the FEM analysis). Substantial bulging is observed in the conventional rectilinear container. FIGS. 8a and 8b show the stress and deflection, respectively in a 1.25 mm wall thickness aluminum curved container also configured to house an 80 cm² cell stack. The curved container defines an inner radius of curvature of about 100 mm and is subjected to a 1 atm internal pressure (lid removed, top surface fully constrained for the FEM analysis). The stiffness of the curved container is about 9 times greater and the strength of the container is about 5 times greater than the conventional rectilinear container. FEM analysis was also performed on a conventional rectilinear container that has ribs, and on curved containers having a radius of curvature of 150 mm and 200 mm, respectively. Note that the conventional rectilinear containers and the curved containers included in the FEM analysis were configured to have a substantially similar weight. The results from the FEM analysis are summarized in Table 1.

As described above, the process of fine blanking can be used to make the curved container even stiffer and stronger, without increasing weight, by moving material from the edges towards the center so the large flat surfaces are thicker towards the center than near the edges, or vice versa. Fine blanking can even be used to move material in the flat sheet to form stiffening ribs in the curved container, again, without increasing the weight.

TABLE 1

| | Stress | | | | Normalized |
|---|---|---|---|---|---|
| Container | (MPA/ | Stress/ | Normalized | Deflection | Deflection |
| Shape | atm) | Yield | Stress | (mm/atm) | (mm) |
| Flat | | | | | |
| Flat (Plain) | 67 | 0.24 | 4.79 | 0.41 | 8.90 |
| Flat (Ribs) | 30 | 0.11 | 2.14 | 0.15 | 3.20 |
| Curved | | | | | |
| 200 mm R | 22 | 0.08 | 1.57 | 0.11 | 2.30 |
| 150 mm R | 19 | 0.07 | 1.36 | 0.07 | 1.60 |
| 100 mm R | 14 | 0.05 | 1.00 | 0.05 | 1.00 |

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell, comprising:
a container including a first portion and a second portion and defining an inner volume therebetween, the first portion including a first surface having a first radius of curvature, the second portion including a second surface having a second radius of curvature, the second surface opposite the first surface and the second radius of curvature different than the first radius of curvature; and
an electrochemical cell stack disposed in the inner volume, the electrochemical cell stack including an anode, a cathode and a separator disposed between the anode and the cathode.

2. The electrochemical cell of claim 1, wherein the electrochemical cell stack further includes a resilient structure disposed in the inner volume, the resilient structure configured to exert a compressive load on the electrochemical cell stack.

3. The electrochemical cell of claim 2, wherein the electrochemical cell stack is a first electrochemical cell stack, the electrochemical cell further comprising:
a second electrochemical cell stack, wherein the resilient structure is disposed between the first electrochemical cell stack and the second electrochemical cell stack.

4. The electrochemical cell of claim 2, wherein the resilient structure includes a spring.

5. The electrochemical cell of claim 2, wherein the resilient structure includes steel wool.

6. The electrochemical cell of claim 2, wherein the resilient structure includes a foam structure.

7. The electrochemical cell of claim 1, wherein a portion of at least one of the first surface of the first housing portion and the second surface of the second housing portion includes a frangible portion, the frangible portion configured to rupture when a gas pressure in the inner volume exceeds a predetermined pressure.

8. An electrochemical cell, comprising:
a container including a first portion and a second portion and defining an inner volume therebetween;
an electrochemical cell stack disposed in the inner volume, the electrochemical cell stack including an anode, a cathode and a separator disposed between the anode and the cathode; and
a resilient structure disposed in the inner volume, the resilient structure configured to preload the electrochemical cell stack with a uniform compressive force.

9. The electrochemical cell of claim 8, wherein the resilient structure is formed of steel wool.

10. The electrochemical cell of claim 8, wherein the electrochemical cell stack is a first electrochemical cell stack, the electrochemical cell further comprising:
a second electrochemical cell stack, wherein the resilient structure is disposed between the first electrochemical cell stack and the second electrochemical cell stack, the resilient structure configured to preload the first electrochemical cell stack and the second electrochemical cell stack with a uniform compressive force.

11. The electrochemical cell of claim 8, wherein the first portion of the container includes a first surface having a first radius of curvature, the second portion of the container includes a second surface having a second radius of curvature, the second surface opposite the first surface and the second radius of curvature different than the first radius of curvature

12. A battery module, comprising:
the electrochemical cell of claim 1; and
a second electrochemical cell,
the electrochemical cell of claim 1 and the second electrochemical cell disposed in a stack such that a gap is present therebetween.

13. The battery module according to claim 12, wherein the gap is configured to permit a circulation of air sufficient to cool the electrochemical cells by natural convection or forced convection.

14. An apparatus, comprising:
a curved battery cell container including:
a first container portion comprising:
a first face having a first radius of curvature;
two opposing end walls extending from the first face; and
two opposing side walls extending from the first face,
the end walls and the side walls defining a container opening configured to
receive a plurality of battery cells and a resilient structure therein; and
a second container portion having a second radius of curvature and configured to:
preload the plurality of battery cells when received in the curved battery cell container; and
hermetically seal the curved container;
wherein one of the opposing end walls comprises an electrical feedthrough configured to accommodate an electrical interconnect.

15. The apparatus of claim 14, wherein the second container portion is a lid.

16. The apparatus of claim 14, wherein the curved battery cell container is a first curved battery cell container, the apparatus further comprising a second curved battery cell container disposed in a stacked relation atop the first curved battery cell container.

17. The apparatus of claim 14, wherein the first radius of curvature is different than the second radius of curvature.

18. The apparatus of claim 14, wherein the curved battery cell container comprises aluminum or carbon-filled plastic.

19. The apparatus of claim 16, wherein the first curved battery cell container and the second curved battery cell container define a gap therebetween, the first curved battery cell container and the second curved battery cell container being in contact at corresponding opposing ends thereof.

20. The apparatus of claim 19, wherein the gap is configured to permit a circulation of air sufficient to cool the first curved battery cell container and the second curved battery cell container by natural convection or forced convection.
